(19) United States
(12) Patent Application Publication
(10) Pub. No.: US 2012/0328682 A1
(43) Pub. Date: Dec. 27, 2012

(54) PARTICLES INCORPORATING ANTIMICROBIAL AGENTS

(75) Inventors: James Bardwell, El Paso, TX (US); Scott A. Tufts, JR., El Paso, TX (US); Aurelia E. Rascon, El Paso, TX (US); Tenoch Benitez, El Paso, TX (US)

(73) Assignee: CAREFUSION 2200, INC., San Diego, CA (US)

(21) Appl. No.: 13/384,483

(22) PCT Filed: Jul. 16, 2010
(86) PCT No.: PCT/US10/42338

§ 371 Date: Aug. 23, 2012

Related U.S. Application Data
(60) Provisional application No. 61/226,382, filed on Jul. 17, 2009.

(51) Int. Cl. A01N 37/52; A01P 1/00; A01N 25/34

(52) U.S. Cl. 424/405; 514/635

(57) ABSTRACT

The present invention relates generally to particles that include one or more antimicrobial agents therein and/or thereon. The particles may be provided with one or more coatings that contain one or more antimicrobial agents, or the one or more antimicrobial agents may be embedded in the particles. The present invention also relates to goods such as medical devices, personal care products, and household devices that incorporate one or more antimicrobial particles. The goods may be provided with one or more coatings that contain the antimicrobial particles, or the antimicrobial particles may be physically embedded in the medical devices. The present invention is further directed towards methods of making such medical devices. The goods incorporating the antimicrobial particles may be used in accordance with methods of killing microorganisms and preventing infections.

### CROSS-REFERENCE TO RELATED APPLICATION

This non-provisional patent application claims the benefit of U.S. Provisional Patent Application No. 61/226,382, filed on Jul. 17, 2009. The disclosure of the prior application is hereby incorporated herein in its entirety by reference.

### BACKGROUND OF THE INVENTION

1. Field of the Invention

The present invention relates generally to particles that include one or more antimicrobial agents incorporated therein and/or thereon. The particles may be provided with one or more coatings that contain one or more antimicrobial agents, or the one or more antimicrobial agents may be embedded in the particles. The present invention is further directed towards methods of making and using such particles. In accordance with certain aspects of the invention, the particles incorporating one or more antimicrobial agents may be used to carry out methods of killing microorganisms.

2. Description of Related Art

Various medical and veterinary devices, such as incise drapes and wound care products, as well as household, personal care, and other products, are formed using solvent-based adhesives. Particularly in the medical and veterinary fields, it is often desirable to provide antimicrobial properties to the products in order to reduce the incidence of infection. However, many commonly-used antimicrobial and antiseptic agents are chemically incompatible with solvents and/or the polymers made using the solvents, leading to reduced stability and effectiveness of the antimicrobial and antiseptic agents.

A number of approaches have been developed in an attempt to address the problem of how to incorporate antimicrobial agents into various articles of manufacture, such as medical devices, personal care products, and household products.

U.S. Pat. No. 5,019,096 describes a method of preparing infection-resistant medical devices including one or more matrix-forming polymers and antimicrobial agents such as a combination of a silver salt and chlorhexidine. The medical devices may have the combination of antimicrobial agents provided in the device, or on the device.

U.S. Published Application No. 2004/0052831 describes treating the surface of a medical device with a solution including one or more solvents and a mixture of chlorhexidine free base and water-soluble chlorhexidine salt, where the mixture increases uptake of chlorhexidine into the medical device.

U.S. Published Application No. 2005/0025800 describes incorporating antimicrobial agents into microparticles in order to provide controlled release of the antimicrobial agents from a latex material.

U.S. Published Application No. 2006/0018966 describes incorporating antimicrobial agents into mesoporous silica nanoparticles, where antimicrobial agents are provided in the pores. The particles may be used in an antimicrobial delivery system that releases an antimicrobial agent over an extended period.

Japanese Unexamined Patent Application No H04-283505 describes a composition that can be used in synthetic resins to provide antimicrobial properties to the surface of the resin. The composition is formed from a silica gel formed from particles that are from 1 to 10 microns in size, and is produced by dispersing 100 weight % type-B silica gel into a mixture of 0.02 to 5 weight % chlorhexidine gluconate in 100 to 500 weight % of ethyl alcohol, methyl alcohol, or another solvent. The silica gel particles are then dried and pulverized.

Japanese Unexamined Patent Application No. H10-025206 describes an antibacterial composition that added to fibers, papers, films, plastics, and inks to provide antimicrobial properties to the finished product. The antimicrobial composition is prepared by forming a silica gel by reacting sodium silicate with an inorganic acid in an aqueous solution containing an antimicrobial quaternary ammonium ion, followed by separating, washing with water, and drying the gel.

There is a need in the art for particles that incorporate one or more antimicrobial agents. There is also a need for goods that contain the particles, such as medical devices, personal care products, and household products. The antimicrobial particles are useful for killing microorganisms that cause infections, and reducing the occurrence of infections.

### SUMMARY OF THE INVENTION

The present invention meets the unmet needs of the art, as well as others, by providing particles that include one or more antimicrobial agents incorporated therein and/or thereon. The particles may be provided with one or more coatings that contain one or more antimicrobial agents, or the one or more antimicrobial agents may be embedded in the particles. The invention also provides articles, such as medical devices, personal care products, and household products, which incorporate one or more antimicrobial agents. According to some aspects, the antimicrobial agents are normally unable to be incorporated into the articles, for example, due to limitations on their solubility and/or form. This invention also improves the stability, sustainability, concentration, and shelf life of antimicrobial agents. This invention also expands the processing methods available for use with otherwise unprocessable antimicrobial agents, enabling their use in normal polymer processing technologies such as rubber and/or plastic injection molding, transfer molding, and extrusion. For example, the articles may be provided with one or more coatings that contain the antimicrobial particles, or the antimicrobial particles may be embedded in the articles. The present invention is further directed towards methods of making articles, such medical devices, personal care products, and household products, which incorporate the antimicrobial particles. The articles incorporating one or more antimicrobial agents may be used in accordance with methods of killing microorganisms.

According to one aspect of the invention, the invention relates to particles including an antimicrobial agent. The particles may be formed from any substance that does not compromise with the effectiveness of the antimicrobial agent.

An additional aspect of the invention relates to a method of preparing antimicrobial particles. The method includes the steps of blending one or more antimicrobial agents with a solvent to form an antimicrobial solution, adding particles to the antimicrobial solution, and evaporating the solvent to form particles having the one or more antimicrobial agents associated therewith. The particles having one or more antimicrobial agents associated therewith may be beneficially incorporated into articles such as medical devices, personal care products, and household products. For antimicrobial agents which have very low solvent solubility, the process of loading the antimicrobial agent into the particles and evaporating the fugitive solvent can be repeated multiple times to increase the final concentration of the agent loaded into the particles. This technique may be used to load any type of particles, including, but not limited to, silica particles.

Another aspect of the invention relates to a medical device incorporating antimicrobial particles. The antimicrobial particles may be provided in one or more coating layers, or they may be embedded in the polymer used to form the medical device. When embedded in the polymer of the medical device, the one or more antimicrobial particles may be mixed directly into the polymer before it is cured.

Yet another aspect of the invention relates to a method of providing a concentrated and/or stabilized antimicrobial agent, comprising the steps of blending an antimicrobial agent with a solvent to form an antimicrobial solution, adding particles to said antimicrobial solution, and evaporating the solvent to form particles having the antimicrobial agent associated therewith.

A further aspect of the invention relates to an antimicrobial incise drape, comprising a polymeric adhesive; a solvent; and antimicrobial particles comprising particles having one or more antimicrobial agents adsorbed directly thereto.

Other novel features and advantages of the present invention will become apparent to those skilled in the art upon examination of the following or upon learning by practice of the invention.

### BRIEF DESCRIPTION OF THE DRAWINGS

FIG. 1 shows the results of zone of inhibition testing against S. aureus and P. aeruginosa after 18 hours. Photographs A) and B) show areas of clearing (zones of inhibition) generated using CHG/Aerosil® 380. Photographs C) and D) show areas of clearing (zones of inhibition) generated using CHG/Aerosil® 200 Pharma.

### DETAILED DESCRIPTION OF THE PREFERRED EMBODIMENTS

The particles for use in the present invention may be formed of any substance that is capable of associating with an antimicrobial agent. Such substances include, without limitation, polymeric shells that encapsulate antimicrobial agent(s), a polymeric matrix having a coating of antimicrobial agent(s), a polymeric matrix having antimicrobial agent(s) dispersed therein, and/or particles formed from inorganic materials.

According to one aspect of the invention, the polymeric shells used to encapsulate antimicrobial agent(s) may be formed from any polymer(s) suitable for use with antimicrobial agents. The polymers may be crosslinked or uncrosslinked, linear or branched, natural or synthetic, thermoplastic or thermosetting, or biostable, biodegradable, bioabsorbable or dissolvable, and may be selected from the group including, but not limited to, acrylate and methacrylate polymers and copolymers, cellulosic polymers and copolymers; polyoxymethylene polymers and copolymers; polyamide polymers and copolymers polycarbonates; polyacrylonitriles; polyvinylpyrrolidones (cross-linked and otherwise); polymers and copolymers of vinyl monomers; polyalkyl oxide polymers and copolymers; glycosaminoglycans; polyester polymers and copolymers; polyether polymers and copolymers; polyisocyanates; polyolefin polymers and copolymers; fluorinated polymers and copolymers; silicone polymers and copolymers; polyurethanes; as well as blends and copolymers of the above.

According to another aspect, the polymeric matrix that may have antimicrobial agent(s) provided therein and/or thereon may be formed from any polymer(s) suitable for use with antimicrobial agents. The polymers may be crosslinked or uncrosslinked, linear or branched, natural or synthetic, thermoplastic or thermosetting, or biostable, biodegradable, bioabsorbable or dissolvable, and may be selected from the group including, but not limited to, acrylate and methacrylate polymers and copolymers; cellulosic polymers and copolymers; polyoxymethylene polymers and copolymer; polyamide polymers and copolymers polycarbonates; polyacrylonitriles; polyvinylpyrrolidones (cross-linked and otherwise); polymers and copolymers of vinyl monomers; polyalkyl oxide polymers and copolymers; glycosaminoglycans; polyester polymers and copolymers; polyether polymers and copolymers; polyisocyanates; polyolefin polymers and copolymers; fluorinated polymers and copolymers; silicone polymers and copolymers; polyurethanes; as well as blends and copolymers of the above.

According to a further aspect, the particles formed from inorganic materials may be selected from materials such as silica, zeolites, and porous titanium dioxide, for example.

According to a further aspect, the particles formed from inorganic materials may be selected from materials such as silica, zeolites, activated carbon, and porous titanium dioxide, for example.

The particles used in accordance with the present invention may be porous or non-porous. According to certain aspects, the particles are porous, and are capable of having antimicrobial agent(s) embedded therein. Particles may be formed using a variety of agents, and may be produced by a variety of methods. Many particles suitable for use in the present invention are commercially available.

According to one aspect of the invention, the particles used to form the antimicrobial particles are silica particles, with fumed silica being particularly preferred.

Regardless of the type of particles used, the particles of the present invention preferably have an average particle size of from 50 to 500 nanometers, more preferably from 75 to 400 nanometers, and most preferably from 100 to 300 nanometers.

Any antimicrobial agent capable of associating with the particles of the invention, while still retaining ability to kill or inhibit the growth of bacteria, fungi, viruses and/or parasites, may be used in accordance with the present invention. For example, suitable antimicrobial agents include, without limitation, bis-biguanide salts (e.g., chlorhexidine digluconate, chlorhexidine diacetate, chlorhexidine dihydrochloride, chlorhexidine diphosphanilate), rifampin, minocycline, silver compounds (silver chloride, silver oxide, silver sulfadiazine), triclosan, octenidine dihydrochloride, quaternary ammonium compounds (e.g., benzalkonium chloride, tridodecyl methyl ammonium chloride, didecyl dimethyl ammonium chloride, chloroallyl hexaminium chloride, benzethonium chloride, methylbenzethonium chloride, cetyl trimethyl ammonium bromide, cetyl pyridinium chloride, dioctyldimethyl ammonium chloride), iron-sequestering glycoproteins (e.g., lactoferrin, ovotransferrin/conalbumin), cationic polypeptides (e.g., protamine, polylysine, lysozyme), surfactants (e.g., SDS, Tween-80, surfactin, Nonoxynol-9) and zinc pyrithione. Further preferred antimicrobial agents include broad-spectrum antibiotics (quinolones, fluoroquinolones, aminoglycosides and sulfonamides), and antiseptic agents (iodine, methenamine, nitrofurantoin, validixic acid).

Octenidine dihydrochloride and bisbiguanide salts are preferred antimicrobial agents for use in the present invention, with chlorhexidine and its salts being particularly preferred. According to some aspects, chlorhexidine digluconate (CHG) is used as the antimicrobial agent.

In one aspect, the present invention relates to the discovery that antimicrobial agents can be rendered more suitable for incorporation into polymers by associating the antimicrobial agents with particles. The antimicrobial agent may be associated with the particle via any type of molecular force, including covalent bonding, hydrogen bonding interactions, dipole interactions, charge-charge interactions, or any other interaction of an electrostatic or other nature that permits the antimicrobial agent to be associated with the particle. Further, the antimicrobial agent may be either directly or indirectly associated with the particle. A direct association is one in which the molecules of the antimicrobial agent are in contact with the material used to form the particle. An indirect association is one in which the molecules of the antimicrobial agent are not in contact with the material used form the particle, for example, where the antimicrobial agent is connected to the particle via a linking molecule. Any of the various linking molecules that are known in the art may be used in accordance with the invention.

The antimicrobial particles of the invention may be prepared using any technique suitable to cause an antimicrobial agent to become associated with a particle. According to one aspect of the invention, antimicrobial particles may be prepared by a method that includes the steps of blending one or more antimicrobial agents with a solvent to form an antimicrobial solution, adding particles to the antimicrobial solution, and evaporating the solvent to form particles having the one or more antimicrobial agents associated therewith. The solvents used to carry out the methods may be any solvents that are capable of dissolving the antimicrobial agent and being evaporated from the particles to leave the antimicrobial agent associated with the particles. The solution containing the antimicrobial agent(s) may utilize any solvent or combination of solvents that is capable of interacting with both the antimicrobial agent and the particles. Such solvents may include water, alcohols, and ethers. Alcohols may include any alcohol, where ethanol is a preferred alcohol solvent. Ethers may include diethyl ether, dimethoxyethane (DME), tert-butyl ethers, and tetrahydrofuran (THF), where THF is a preferred ether solvent. Water is a preferred solvent. Additional solvents may include, for example, organic siloxanes (silicones) and paraffins.

In another aspect, the present invention relates to the discovery that surprising amounts of antimicrobial agents may be incorporated into the particles, providing a concentrated source of antimicrobial agent. Such particles may be used to provide a variety of articles with antimicrobial properties.

The present invention also relates to the discovery that water-based antimicrobial agents, such as chlorhexidine gluconate, can be provided in a stable, dry form that permits them to be incorporated directly into articles such as medical devices. For example, CHG is traditionally supplied as a 20% aqueous solution, and attempts to incorporate CHG into water-free applications have not been successful. The present invention includes a method of providing a stable form of CHG that is dry (contains little or no water). Such a stable form of CHG may be used in a wide variety of technologies for preparing antimicrobial articles.

According to one embodiment of the invention, a method of stabilizing an antimicrobial agent is provided. The method includes blending an antimicrobial agent with a solvent to form an antimicrobial solution, adding particles to said antimicrobial solution, and evaporating the solvent to form stable particles having the antimicrobial agent associated therewith. Depending on the antimicrobial agent and the type of particle used, and whether the particle is porous or non-porous, the antimicrobial agent may form a coating on the outer surface of the particle, be absorbed into the particle, be adsorbed onto the particle, or otherwise become embedded in the particle. The present invention is not to be construed as being limited by the nature of the association between the antimicrobial agent and the particle.

The methods of the invention also include methods of stabilizing CHG by providing an aqueous solution of chlorhexidine gluconate and adding fumed silica particles to the aqueous solution of chlorhexidine gluconate. The water is then removed from the microporous particles/microspheres (e.g., through evaporation), thereby forming dry microspheres with chlorhexidine gluconate incorporated therein. Such particles/microspheres having chlorhexidine incorporated therein are stable in non-aqueous applications. By incorporating CHG into microporous particles/microspheres, the ease of handling of CHG is improved, which permits CHG to be used in applications that were not feasible for liquid CHG.

The particles having one or more antimicrobial agents associated therewith may be incorporated into a variety of goods and materials, without limitation, in order to provide the goods and materials with antimicrobial properties.

Personal care products that may incorporate antimicrobial particles include soaps, toothpastes, mouthwashes, gums, powders, medical dressings, creams, lotions, veterinary medicine products, etc.

Household goods that may incorporate the antimicrobial particles of the present invention include paints, adhesives, countertops, flooring, cleaning implements, appliances, etc.

Other applications are also envisioned, such as products for use in clean rooms, industrial settings, and any other environment where antimicrobial measures may be useful.

The antimicrobial particle of the present invention may also be incorporated into medical devices. According to one aspect, the antimicrobial particles are not adversely affected by conditions typically encountered during formation of the medical device, such as use of solvents and extreme temperatures. This aspect of the invention is also useful for stabilizing antimicrobial agents that are otherwise unstable under conditions commonly encountered in a medical setting in which a particular medical device is used. For example, prior to stabilization, the antimicrobial agent may exhibit reduced effectiveness under conditions of temperature, humidity, exposure to bodily fluids or chemicals, or other conditions commonly-encountered in a medical environment. After the antimicrobial agent has been associated with particles/microspheres, it preferably exhibits improved stability when subjected to one or more of these conditions.

In accordance with one aspect of the present invention, the antimicrobial particles may also be incorporated into medical adhesives, such as pressure sensitive adhesives, and adhesives contained in medical incise drape formulations. Presently-preferred adhesives belong to the Dura-Tak® line of adhesives (manufactured by Henkel AG & Co. KGaA, Düsseldorf, Germany), and the Dermacryl® line of adhesives (manufactured by AkzoNobel N.V., Amsterdam, The Netherlands), although the invention is not limited to use with these adhesives.

Medical devices that may beneficially incorporate the antimicrobial particles of the present invention include any medical device or veterinary medicine product, which comes into contact with disease-causing bacteria, viruses, fungi, and/or parasites during use. Such medical devices include, without limitation, wound care devices (bandages, dressings), intrauterine devices, intravaginal devices, intraintestinal devices, endotracheal tubes, biosensors, implants, artificial organs, condoms, dental prostheses, orthodontic devices, contact lenses, tissue dressings, bandages, drapes, gowns, masks, gloves, and adhesives (such as those used to prepare incise drapes). However, the present invention is applicable to any medical devices that come into contact with a patient, which may include, but are not limited to, devices such as stethoscopes, and blood pressure cuffs.

The medical devices can be formed of any materials that are compatible with the environment in which they are used. The medical devices of the present invention may be formed from essentially any material that is capable of retaining the antimicrobial agent therein or thereon, and that allows for release of the antimicrobial agent. According to one aspect, the material used to form the medical device is a polymer. Exemplary polymers may be crosslinked or uncrosslinked, linear or branched, natural or synthetic, thermoplastic or thermosetting, or biostable, biodegradable, bioabsorbable or dissolvable, and may be selected from the group including, but not limited to, acrylate and methacrylate polymers and copolymers; cellulosic polymers and copolymers; polyoxymethylene polymers and copolymers; polyamide polymers and copolymers polycarbonates; polyacrylonitriles; polyvinylpyrrolidones (cross-linked and otherwise); polymers and copolymers of vinyl monomers; polyalkyl oxide polymers and copolymers; glycosaminoglycans; polyester polymers and copolymers; polyether polymers and copolymers; polyisocyanates; polyolefin polymers and copolymers; fluorinated polymers and copolymers; silicone polymers and copolymers; polyurethanes; biopolymers, such as polypeptides, proteins, polysaccharides and fatty acids (and esters thereof), including fibrin, fibrinogen, collagen, elastin, chitosan, gelatin, starch, and glycosaminoglycans such as hyaluronic acid; as well as blends and copolymers of the above.

The antimicrobial particles are preferably included in or on the articles in amounts that are effective for reducing the amount of microbes on the surface of the device. According to a further aspect, the antimicrobial particles are provided in amounts that are effective for eliminating all microbes on the surface of the device. In particular, where the article is a medical device, the antimicrobial particles are provided in amounts that are microbicidally or microbistatically effective, while not being toxic to the patient in the context of the application for which the medical device is being used (i.e., skin contacting device vs. blood contacting device). The amount of antimicrobial agent(s) necessary to achieve the desired effect will vary based on factors including, but not limited to, the microorganisms that are likely to be encountered during use of the article, the manner in which the antimicrobial particles are incorporated into the article (i.e., as a coating, or embedded within the article), the specific antimicrobial agents and particle materials selected, and the particular application of the article.

Preferably the antimicrobial particles are included in or on the articles in amounts that are adequate to kill or restrict the growth of one or more of the following microbes: coagulase-negative Staphylococci, Enterococci, fungi, Candida albicans, Staphylococcus aureus, Enterobacter species, Enterococcus faecalis, Staphylococcus epidermidis, Streptococcus viridans, Escherichia coli, Klebsiella pneumoniae, Proteus mirabilis, Pseudomonas aeruginosa, Acinetobacter baumannii, Burkholderia cepacia, Varicella, Clostridium difficile, Clostridium sordellii, Hepatitis A, Hepatitis B, Hepatitis C, HIV/AIDS, methicillin-resistant Staphylococcus aureus (MRSA), mumps, norovirus, parvovirus, poliovirus, rubella, SARS, S. pneumoniae (including drug resistant forms), vancomycin-intermediate Staphylococcus aureus (VISA), vancomycin-resistant Staphylococcus aureus (VRSA), and vancomycin-resistant Enterococci (VRE). It is considered to be within the ability of one skilled in the art to determine such amounts.

The incorporation of antimicrobial particles into the articles of the present invention may follow one of two approaches: (1) providing a coating containing the antimicrobial particles on the article; or (2) incorporating the antimicrobial particles into the articles. According to some aspects of the invention, the antimicrobial particles may provide a sustained release of the antimicrobial agent, allowing long-term antimicrobial efficacy. According to other aspects of the invention, the antimicrobial particles may provide a rapid release of the antimicrobial agent to provide a quick kill. The context in which the article is used, the manner in which the antimicrobial particles are incorporated into the article (i.e., as a coating, or embedded within the article), and the specific antimicrobial agents and particle materials selected will have an impact on the release properties.

The present invention may also be used in accordance with methods of killing microorganisms on contact. Such methods include providing an article, and incorporating antimicrobial particles therein or thereon in an amount sufficient to kill any microorganisms that are found in the area surrounding the medical device. The amount of antimicrobial agent(s) will vary based on the microorganisms that are likely to be encountered, and the particular application of the article.

These and other aspects of the invention are further described in the non-limiting Examples set forth below.

### EXAMPLES

### Example 1

### Preparation of Silica Particles Incorporating Chlorhexidine Gluconate (CHG)

Fumed Silica Particles (CAB-O-SIL® Grade M-5P from the Cabot Corp., Business & Technical Center, 157 Concord Rd., Billerica, Mass. 01821) were mixed into a 20% w/v CHG solution to create a thick paste. The paste was then thinned with isopropyl alcohol or acetone and evaporated to dryness. The dried silica cake was readily friable. The dried silica cake was reduced to a fine, fluffy, white powder by gentle grinding.

After drying, the powder was analyzed and found to release 100% of its chlorhexidine content when subjected to a simple water extraction. The concentration of CHG in these powders reached as high as 37% wt.

### Example 2

### Efficacy Testing of Pressure Sensitive Adhesive Containing Silica Particles Incorporating CHG

The fine, lightweight, powder obtained in Example 1 may be added to a sample of pressure sensitive adhesive. The powder readily forms a suspension in the adhesive matrix. The formulation details are as follows:

SiO₂—CHG (37.1% API) 2.695 grams

Duro-Tak 87-900A adhesive 97.305 grams (National Starch and Chemical, Bridgewater, N.J.)

Total Weight 100.0 grams

The pressure sensitive adhesive containing the CHG-bearing silica powder was coated onto standard 6 mm Zone of Inhibition (ZOI) test disks and used in a ZOI test involving S. aureus and P. aeruginosa. The tests show a strong antimicrobial activity against S. aureus emanating from the adhesive matrix. Although no ZOI was observed in the P. aeruginosa test, this measurement does not take into account clearing under the disk. Results are reported in Table 1. The test demonstrates that silica particles incorporating CHG released CHG at a concentration sufficient to produce a ZOI in the S. aureus test sample that was comparable to (and greater than) the positive control, but not at a concentration sufficient to produce a comparable ZOI in the P. aeruginosa test sample.

TABLE 1
Plate 1 Read counterclockwise starting from “−” negative control

| | Largest clearing | | |
|---|---|---|---|
| | diameter (mm) | | |
| | Gram (+) | Gram (−) | Disk Diameter |
| Sample | S. aureus | P. aeruginosa | (mm) |
| Blank Disc | 0.0 | 0.0 | 6.0 |
| (Negative Control) | | | |
| Control—2.0% CHG/IPA | 18.0 | 8.0 | 6.0 |
| (Positive Control) | | | |
| Adhesive compound | 0.0 | 0.0 | 6.0 |
| (No Active Ingredient) | | | |
| Adhesive compound | 20.0 | 0.0 | 6.0 |
| with CHG-Loaded Silica | | | |
| (Active Added) | | | |

### Example 3

### Efficacy Testing of Silica Particles Incorporating CHG

Two types of silica were used to carry out efficacy testing: Aerosil® 380 (industrial grade) and Aerosil 200® Pharma (pharmaceutical grade) (hydrophilic fumed silica having surface area in m²/g corresponding to number used in product name, manufactured by Evonik Degussa GmbH, Frankfurt am Main, Germany). Several mixtures of CHG (provided as a solution of CHG 20.3% w/v) and silica were prepared with each type of silica. The following method was used to formulate the CHG/silica:
1. Required quantities of CHG and silica were weighed for each mixture.
2. CHG was mixed with the silica using 70% v/v IPA as a solvent. Additional 70% IPA was added to the mixture to obtain a homogenous gel consistency. The mixture was poured onto a tray, evenly spread, and left to dry at room temperature, approximately 22° C.
3. Once dry, the mixture was minced using a mortar and pestle in order to obtain a fine powder.
4. Pellets 6 mm diameter were made for each mixture using a manual pellet press. The pellets were then used to evaluate the antimicrobial activity of the mixtures.

To evaluate the antimicrobial activity of each sample, a Zone of Inhibition test was performed. In the Zone of Inhibition test, a known quantity of bacteria is grown on agar plates in the presence of thin discs containing antibiotic (or antiseptic). If the bacteria are susceptible to a particular antibiotic (or antiseptic), an area of clearing surrounds the disc where bacteria are not capable of growing. This zone is called a Zone of Inhibition. The following is a summary of the main procedure used to conduct the testing:
1. Three Mueller-Hinton agar plates were inoculated with P. aeruginosa using a sterile cotton swab dipped previously into a P. aeruginosa saline suspension. Each agar plate had a 6 mm pellet of each of the CHG/silica mixtures along with a negative and a positive control. This procedure was repeated and performed with S. aureus. Plates were placed inside an incubator at 32.5° C. (±2.5° C.) for 16 to 18 hours.
2. Using a light box to improve visibility, Zone of Inhibition diameters were measured on the back of the inverted Mueller-Hinton agar plates.

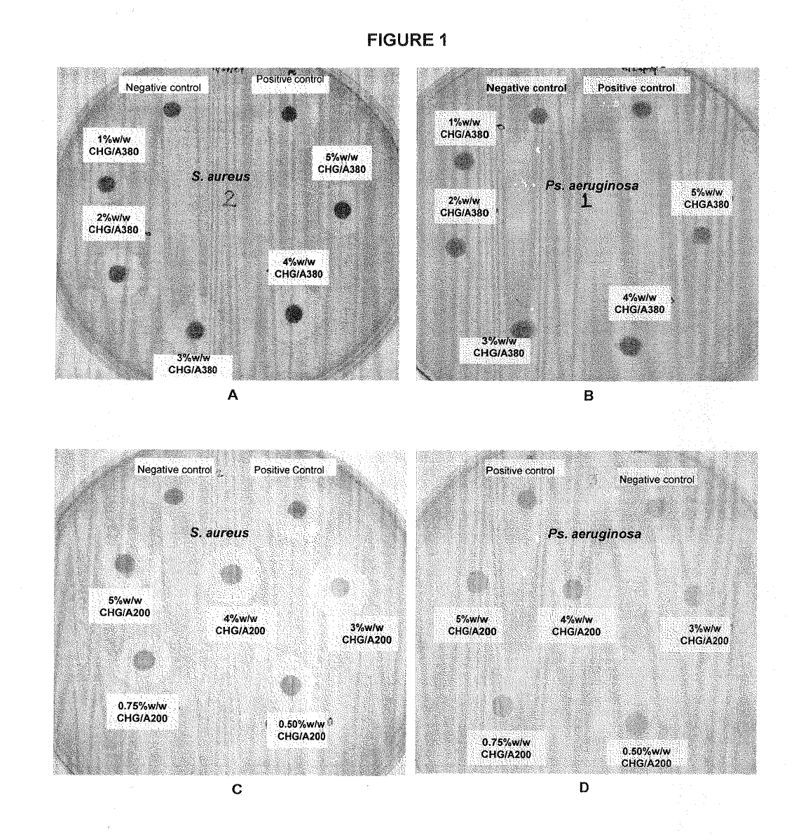

Testing was conducted at a concentration of 15% w/w CHG/Aerosil® 380 and tested concentrations down to 10% w/w CHG/Aerosil® 380. Upon determining that the mixtures had antimicrobial activity, new mixtures were formulated by reducing the concentration to 8% w/w CHG/Aerosil® 380, and down to 1% w/w CHG/Aerosil® 380. This permitted a determination of the lowest possible concentration that exhibited antimicrobial activity. As shown in Table 2, the sample containing 2% w/w CHG/Aerosil® 380 was the mixture with the lowest concentration that demonstrated antimicrobial activity against both gram negative and gram positive microorganisms. Photographs of the zone of inhibition test results are shown in FIG. 1A-B.

Aerosil® 380 preliminary results suggest that Aerosil® 200 Pharma could give better results at even lower CHG concentrations given that the purity of the pharmaceutical grade silica is higher than industrial grade. Testing was conducted at a concentration of 3% w/w CHG/Aerosil® 200 Pharma and concentrations up to 5% w/w CHG/Aerosil® 200 Pharma were tested. Upon discovering that the mixtures had antimicrobial activity, new mixtures were formulated by reducing the concentration of CHG/Aerosil® 200 Pharma to obtain the lowest concentration with antimicrobial activity. As shown in Table 3, the 0.5% w/w CHG/Aerosil® 200 Pharma mixture showed a slightly zone larger that the diameter of disk. Photographs of the zone of inhibition test results are shown in FIGS. 1C-D.

TABLE 2
Zone of inhibition diameters (mm) obtained for mixtures containing CHG
and Aerosil ® 380 silica (NZ = No zone and NS = No sample).

| | Zone of inhibition diameter (mm) | | | | | | | | | | | |
|---|---|---|---|---|---|---|---|---|---|---|---|---|
| | Staphylococcus aureus | | | | | | Pseudomonas aeruginosa | | | | | |
| | Negative | Positive | | | | | Negative | Positive | | | | |
| Samples | control | Control | Plate 1 | Plate 2 | Plate 3 | Avg. | control | control | Plate 1 | Plate 2 | Plate 3 | Avg. |
| 15% w/w | NZ | 23 | 21 | 21 | 21 | 21 | NZ | 17 | 15 | 14 | NS | 15 |
| CHG/Aerosil ® 380 | | | | | | | | | | | | |
| 10% w/w | | | 18 | 20 | 20 | 19 | | | 14 | 12 | 13 | 10 |
| CHG/Aerosil ® 380 | | | | | | | | | | | | |
| 8% w/w | | | 20 | 20 | 20 | 20 | | | 9 | 10 | 10 | 10 |
| CHG/Aerosil ® 380 | | | | | | | | | | | | |
| 7% w/w | NZ | 23 | 20 | 21 | 20 | 20 | NZ | 17 | 13 | 13 | 13 | 13 |
| CHG/Aerosil ® 380 | | | | | | | | | | | | |
| 6% w/w | | | 21 | 20 | 20 | 20 | | | 13 | 11 | 11 | 12 |
| CHG/Aerosil ® 380 | | | | | | | | | | | | |
| 5% w/w | | | 19 | 19 | 18 | 19 | | | 10 | 12 | 10 | 11 |
| CHG/Aerosil ® 380 | | | | | | | | | | | | |
| 4% w/w | | | 17 | 19 | 18 | 18 | | | 10 | 10 | 12 | 11 |
| CHG/Aerosil ® 380 | | | | | | | | | | | | |
| 3% w/w | | | 17 | 17 | 17 | 17 | | | 8 | 9 | 8 | 8 |
| CHG/Aerosil ® 380 | | | | | | | | | | | | |
| 2% w/w | NZ | 22 | 18 | 18 | 17 | 18 | NZ | 16 | 7 | 6 | 6 | 6 |
| CHG/Aerosil ® 380 | | | | | | | | | | | | |
| 1% w/w | | | 17 | 15 | 16 | 16 | | | NZ | NZ | NZ | N/A |
| CHG/Aerosil ® 380 | | | | | | | | | | | | |

TABLE 3
Zone of inhibition diameters (mm) obtained for mixtures containing CHG
and Aerosil ® 200 silica (NZ = No inhibition zone).

| | Zone of inhibition diameter (mm) | | | | | | | | | | | |
|---|---|---|---|---|---|---|---|---|---|---|---|---|
| | Staphylococcus aureus | | | | | | Pseudomonas aeruginosa | | | | | |
| | Negative | Positive | Plate | | | | Negative | Positive | | | | |
| Samples | control | Control | 1 | Plate 2 | Plate 3 | Avg. | control | control | Plate 1 | Plate 2 | Plate 3 | Avg. |
| 5% w/w CHG/Aerosil ® | NZ | 22 | 20 | 20 | 21 | 20 | NZ | 16 | 9 | 11 | 11 | 10 |
| 200 Pharma | | | | | | | | | | | | |
| 4% w/w CHG/Aerosil ® | | | 20 | 21 | 21 | 21 | | | 12 | 10 | 10 | 11 |
| 200 Pharma | | | | | | | | | | | | |
| 3% w/w CHG/Aerosil ® | | | 19 | 20 | 19 | 19 | | | 9 | 8 | 9 | 9 |
| 200 Pharma | | | | | | | | | | | | |
| 2% w/w CHG/Aerosil ® | NZ | 24 | 19 | 20 | 18 | 19 | NZ | 16 | 11 | 11 | 11 | 11 |
| 200 Pharma | | | | | | | | | | | | |
| 1% w/w CHG/Aerosil ® | | | 18 | 18 | 18 | 18 | | | 10 | 10 | 10 | 10 |
| 200 Pharma | | | | | | | | | | | | |
| 0.75% w/w | NZ | 23 | 17 | 16 | 18 | 17 | NZ | 16 | 7 | 7 | 8 | 7 |
| CHG/Aerosil ® 200 | | | | | | | | | | | | |
| Pharma | | | | | | | | | | | | |
| 0.5% w/w CHG/ | | | 15 | 15 | 14 | 15 | | | 6.5 | 6.5 | 6.5 | 6.5 |
| Aerosil ® 200 Pharma | | | | | | | | | | | | |

It will, of course, be appreciated that the above description has been given by way of example only and that modifications in detail may be made within the scope of the present invention.

Throughout this application, various patents and publications have been cited. The disclosures of these patents and publications in their entireties are hereby incorporated by reference into this application, in order to more fully describe the state of the art to which this invention pertains.

The invention is capable of considerable modification, alteration, and equivalents in form and function, as will occur to those ordinarily skilled in the pertinent arts having the benefit of this disclosure.

While the present invention has been described for what are presently considered the preferred embodiments, the invention is not so limited. To the contrary, the invention is intended to cover various modifications and equivalent arrangements included within the spirit and scope of the detailed description provided above.

1-17. (canceled)

18. Antimicrobial particles comprising silica particles having one or more antimicrobial agents adsorbed directly thereto, wherein the antimicrobial particles are formed by dissolving the one or more antimicrobial agents in a solvent to form a solution, adding the silica particles to the solution to form a paste, and evaporating the solvent.

19. The antimicrobial particles of claim 18, wherein the antimicrobial agent is selected from the group consisting of bisbiguanide salts, bipyridine salts, triclosan, quaternary ammonium compounds, iron-sequestering glycoproteins, cationic polypeptides, surfactants, zinc pyrithione, broad-spectrum antibiotics, and antiseptic agents.

20. The antimicrobial particles of claim 19, wherein the bisbiguanide salt is selected from the group consisting of octenidine dihydrochloride, chlorhexidine digluconate, chlorhexidine diacetate, chlorhexidine dihydrochloride, and chlorhexidine diphosphanilate.

21. The antimicrobial particles of claim 18, wherein the antimicrobial agent is provided in an amount adequate to kill or restrict the growth of one or more microbes selected from the group consisting of coagulase-negative Staphylococci, Enterococci, fungi, Candida albicans, Staphylococcus aureus, Enterobacter species, Enterococcus faecalis, Staphylococcus epidermidis, Streptococcus viridans, Escherichia coli, Klebsiella pneumoniae, Proteus mirabilis, Pseudomonas aeruginosa, Acinetobacter baumannii, Burkholderia cepacia, Varicella, Clostridium difficile, Clostridium sordellii, Hepatitis A, Hepatitis B, Hepatitis C, HIV/AIDS, methicillin-resistant Staphylococcus aureus (MRSA), mumps, norovirus, parvovirus, poliovirus, rubella, SARS, S. pneumoniae (including drug resistant forms), vancomycin-intermediate Staphylococcus aureus (VISA), vancomycin-resistant Staphylococcus aureus (VRSA), and vancomycin-resistant Enterococci (VRE).

22. An article comprising the antimicrobial particles of claim 21, wherein the antimicrobial particles are provided in one or more coating layers.

23. An article comprising the antimicrobial particles of claim 21, wherein the antimicrobial particles are embedded in a material used to form the article.

24. A method of preparing antimicrobial particles comprising:
blending one or more antimicrobial agents with a solvent to form an antimicrobial solution,
combining particles with the antimicrobial solution, and
evaporating the solvent to form particles having the one or more antimicrobial agents associated therewith.

25. The method of claim 24, wherein the solvent is selected from the group consisting of water, alcohols, ethers, organic siloxanes, and paraffins.

26. The method of claim 24, wherein the antimicrobial agent is selected from the group consisting of bisbiguanide salts, bipyridine salts, triclosan, quaternary ammonium compounds, iron-sequestering glycoproteins, cationic polypeptides, surfactants, zinc pyrithione, broad-spectrum antibiotics, and antiseptic agents.

27. The method of claim 26, wherein the bisbiguanide salt is selected from the group consisting of octenidine dihydrochloride, chlorhexidine digluconate, chlorhexidine diacetate, chlorhexidine dihydrochloride, and chlorhexidine diphosphanilate.

28. The method of claim 24, further comprising grinding the particles after the solvent has evaporated.

29. A method of stabilizing chlorhexidine gluconate, comprising the steps of:
providing an aqueous solution comprising chlorhexidine gluconate and water;
adding fumed silica particles to said aqueous solution of chlorhexidine gluconate to form a paste; and
evaporating the water from the slurry of silica particles, thereby forming fumed silica particles having chlorhexidine gluconate incorporated therein,
wherein said fumed silica particles having chlorhexidine incorporated therein are stable in non-aqueous applications.

30. The method of claim 29, further comprising grinding the fumed silica particles after the solvent has evaporated.

31. An antimicrobial incise drape, comprising:
a polymeric adhesive;
a solvent; and
antimicrobial particles comprising particles having one or more antimicrobial agents adsorbed directly thereto.

32. The antimicrobial incise drape of claim 31, wherein the antimicrobial agent is selected from the group consisting of bisbiguanide salts, bipyridine salts, triclosan, quaternary ammonium compounds, iron-sequestering glycoproteins, cationic polypeptides, surfactants, zinc pyrithione, broad-spectrum antibiotics, and antiseptic agents.

33. The antimicrobial incise drape of claim 32, wherein the bisbiguanide salt is selected from the group consisting of octenidine dihydrochloride, chlorhexidine digluconate, chlorhexidine diacetate, chlorhexidine dihydrochloride, and chlorhexidine diphosphanilate.

34. The antimicrobial incise drape of claim 31, wherein the antimicrobial agent is provided in an amount adequate to kill or restrict the growth of one or more microbes selected from the group consisting of coagulase-negative Staphylococci, Enterococci, fungi, Candida albicans, Staphylococcus aureus, Enterobacter species, Enterococcus faecalis, Staphylococcus epidermidis, Streptococcus viridans, Escherichia coli, Klebsiella pneumoniae, Proteus mirabilis, Pseudomonas aeruginosa, Acinetobacter baumannii, Burkholderia cepacia, Varicella, Clostridium difficile, Clostridium sordellii, Hepatitis A, Hepatitis B, Hepatitis C, HIV/AIDS, methicillin-resistant Staphylococcus aureus (MRSA), mumps, norovirus, parvovirus, poliovirus, rubella, SARS, S. pneumoniae (including drug resistant forms), vancomycin-intermediate Staphylococcus aureus (VISA), vancomycin-resistant Staphylococcus aureus (VRSA), and vancomycin-resistant Enterococci (VRE).
